(19) United States
(12) Patent Application Publication
(10) Pub. No.: US 2019/0267758 A1
(43) Pub. Date: Aug. 29, 2019

(54) ELECTRICITY CHARGING PLUG DEVICE, ELECTRICITY CHARGING CONNECTION DEVICE, ELECTRICITY CHARGING DEVICE AND ELECTRIC VEHICLE

(71) Applicant: LG INNOTEK CO., LTD., Seoul (KR)

(72) Inventors: YUN YOUNG JUNG, Seoul (KR); JONG SEOK PARK, Seoul (KR); JAE HOO JUNG, Seoul (KR); SU HYUN HAN, Seoul (KR)

(21) Appl. No.: 16/345,412

(22) PCT Filed: Nov. 29, 2017
(86) PCT No.: PCT/KR2017/013850

§ 371 Date: Apr. 26, 2019

(30) Foreign Application Priority Data
Nov. 30, 2016 (KR) 10-2016-0161322
Nov. 30, 2016 (KR) 10-2016-0161323

(51) Int. Cl. H01R 13/639; B60L 50/50; B60L 53/16; B60L 53/30; H01R 13/10; H01R 13/629; H02J 7/00

(52) U.S. Cl. CPC H01R 13/639; B60L 50/50; B60L 53/16; B60Y 2200/91; H01R 13/10; H01R 13/629; H02J 7/0042; B60L 53/30

(57) ABSTRACT

An electricity charging plug device comprises: a housing; an operating part of which a portion is exposed to the outside of the housing; a locking part connected to the operating part and slidably coupled to a vehicle connector when the device is coupled to the vehicle connector; a moving part connected to the operating part and having inclination changes according to the movement of the operating part; and a pressing part connected to the moving part so as to move toward the vehicle connector according to the movement of the moving part, wherein the pressing part protrudes outwards of the housing according to the movement of the moving part to press the vehicle connector.

### TECHNICAL FIELD

The teachings in accordance with exemplary and non-limiting embodiments of this invention relate generally to electricity charging plug device, electricity charging connection device, electricity charging device and electric vehicle.

### BACKGROUND ART

Researches are being briskly waged on electric vehicles because the electric vehicles may be a high likely alternative capable of solving pollution and energy problems. In general, the electric vehicle is a vehicle securing a power by driving AC or DC motor mainly using a battery power, and may be largely classified into a battery-only electric vehicle and a hybrid electric vehicle, where the battery-only electric vehicle drives a motor using a battery power and recharges when the battery is completely depleted, and the hybrid electric vehicle charges a battery by activating an electric generation, and drives by an electric motor through charge of a battery and using the power generated from the electric motor.

Hence, in order to operate an electric vehicle, a charging means is required in order to store an electric power in a built-in battery by receiving the electric power from an outside. In general, charging of an electric vehicle is realized by mutually connecting an outside charging station and a vehicular battery using a physical cable.

FIG. 1 is a cross-sectional view illustrating a charging state of an electric vehicle according to prior art.

Referring to FIG. 1, the charging of an electric vehicle according to prior art is realized by coupling of a vehicular connector (1) and an electricity charging plug device (6). The vehicular connector (1) is mounted on an electric vehicle, and the electricity charging plug device (6) is mounted on a distal end of a cable extended from an outside charging station.

The vehicular connector (1) may be formed with a reception groove (3) inserted at one surface of a housing (2) by the electricity charging plug device (6), and a floor surface of the reception groove (3) may be disposed with one or more charging terminal (4). Furthermore, the electricity charging plug device (6) may be formed with a charging plug (5) inserted by the charging terminal (4) when being inserted into the reception groove (3). Thus, while a distal end, i.e., a portion of the electricity charging plug device (6) is inserted into the reception groove (3), the charging may be realized by coupling between the charging terminal (4) and the charging plug (5).

In case the electric vehicle is charged using the abovementioned charging connection device, there may be generated the following problems at the time when the vehicular connector (1) and the electricity charging plug device (6) are coupled.

First, because the electric vehicle is supplied with a high powered electric energy, a charging safety can be guaranteed only when the coupling between the vehicular connector (1) and the electricity charging plug device (6) are securely established. Therefore, a separate element must be disposed for coupling between an outside of the electricity charging plug device (6) and an outside of the vehicular connector (1), or a cross-section of the electricity charging plug device (6) must be correspondingly formed with that of the reception groove (3) to thereby reinforce or strengthen the coupling force between the electricity charging plug device (6) and the vehicular connector (1).

However, due to the reinforced coupling means, a user must use an excessive force in order to insert the electricity charging plug device (6) into the reception groove (3) or to pull off the electricity charging plug device (6) from the reception groove (3), causing an inconvenience in using the same.

Particularly, due to repeated charging, the electricity charging plug device (6) made of plastic and the vehicular connector (1) are easy to be broken or damaged, whereby the airtightness between the charging terminal (4) and the charging plug (5) may be damaged.

As a result, the charging connection device of electric vehicle according to the prior art suffers from disadvantages of difficulty in satisfying both the convenience in usage and the charging safety.

### DETAILED DESCRIPTION OF THE INVENTION

### Technical Subject

The present invention is to provide electricity charging plug device, electricity charging connection device, electricity charging device and electric vehicle constated to guarantee a charging safety and to improve the convenience in use.

### Technical Solution

In one general aspect of the present invention, there is provided electricity charging plug device, the device comprising:
a housing;
an operating part of which a portion is exposed to the outside of the housing;
   a locking part connected to the operating part and slidably coupled to a vehicle connector when the device is coupled to the vehicle connector;
   a moving part connected to the operating part and having inclination changes according to the movement of the operating part; and
   a pressing part connected to the moving part so as to move toward the vehicle connector according to the movement of the moving part, wherein
   the pressing part protrudes outwards of the housing according to the movement of the moving part to press the vehicle connector.

Preferably, but not necessarily, the operating part, the locking part and the moving part may be connected by a first axis.

Preferably, but not necessarily, the moving part and the pressing part may be connected by a second axis.

Preferably, but not necessarily, the operating part may include a button part pressed by a user, and a force transfer part transferring a force applied to the operating part to the locking part and the moving part.

Preferably, but not necessarily, the locking part may further include an elastic member providing elasticity to the locking part.

Preferably, but not necessarily, the device may further comprise a connection terminal connected to the vehicle connector.

In another general aspect of the present invention, there is provided electricity charging connection device, comprising:
a base including a coupling groove into which a charging plug is inserted;
a fixing frame formed with a charging terminal electrically connected to the charging plug;
a moving frame interposed between the fixing frame and the base; and
an elastic member applying elasticity to the moving frame by being contacted to the moving frame; wherein
the fixing frame may include a guide groove and the moving frame may include a guide gear moving along the guide groove.

Preferably, but not necessarily, the moving frame may include a moving frame body disposed at an inside of the coupling groove and a stopper having a diameter greater than that of the body.

Preferably, but not necessarily, the coupling groove of the base may have a diameter smaller than that of the stopper.

Preferably, but not necessarily, the elastic member may be such that a distal end may be contacted to one surface of the moving frame and the other end may be accommodated into an elastic member reception groove of the fixing frame.

Preferably, but not necessarily, the guide gear may further include a guide lug moving along the guide groove.

Preferably, but not necessarily, the guide groove may include an incoming path into which the guide protrude comes in and an outgoing path from which the guide lug goes out, wherein a reception groove may be included between the incoming path and the outgoing path in order to accommodate the guide lug.

Preferably, but not necessarily, an inner circumferential surface at an inlet side of the guide groove may be formed with an inclination toward the incoming path of the guide lug.

Preferably, but not necessarily, the moving frame may further include a guide coupling part coupled to the guide gear.

Preferably, but not necessarily, the moving frame may include a plurality of through holes through which the charging terminal passes.

Preferably, but not necessarily, the base may include a locking lug protruding from an outer circumferential surface of the coupling groove.

Preferably, but not necessarily, the stopper may include, at a rear surface thereof, an elastic member coupling part into which one end of the elastic member is inserted.

In still further general aspect of the present invention, there is provided an electric vehicle mounted with electricity charging connection device for charging, wherein the electricity charging connection device comprises:
a base including a coupling groove into which a charging plug is inserted;
a fixing frame formed with a charging terminal electrically connected to the charging plug;
a moving frame interposed between the fixing frame and the base; and
an elastic member applying elasticity to the moving frame by being contacted to the moving frame; wherein
the fixing frame may include a guide groove and the moving frame may include a guide gear moving along the guide groove.

### Advantageous Effects of the Invention

The electricity charging plug device, electricity charging connection device, electricity charging device and electric vehicle according to the present invention has an advantageous effect in that the electricity charging plug device can be easily separated because a pressing axis presses a floor surface when the electricity charging plug device is separated from the vehicle connector. As a result, a user can manipulate the electricity charging plug device without any separate force to thereby provide a user convenience.

Another advantageous effect is that a coupling safety can be guaranteed between the electricity charging coupling device and the electricity charging connection device during charging by fixing the movement state of moving frame through accommodation of guide lug on a stopping groove.

Furthermore, the electricity charging coupling device has an advantageous effect in that a user can exercise a less force because of being disengaged from the electricity charging connection device by using elasticity of an elastic member.

### BRIEF DESCRIPTION OF DRAWINGS

FIG. 1 is a cross-sectional view illustrating a charging state of an electric vehicle according to prior art.

FIG. 2 is a perspective view of a charging connection device of an electric vehicle according to an exemplary embodiment of the present invention.

FIG. 3 is a perspective view illustrating a coupled state between vehicle connector and electricity charging plug device according to an exemplary embodiment of the present invention.

FIG. 4 is a perspective view of electricity charging plug device according to an exemplary embodiment of the present invention.

FIG. 5 is a cross-sectional view illustrating an inner element of electricity charging plug device according to an exemplary embodiment of the present invention.

FIG. 6 is a perspective view of an inner element of electricity charging plug device according to an exemplary embodiment of the present invention.

FIG. 7 is a perspective view of a removable (attachable/detachable) module according to an exemplary embodiment of the present invention.

FIG. 8 is a cross-sectional view illustrating operation of removable module according to an exemplary embodiment of the present invention.

FIG. 9 is a cross-sectional view illustrating an inner state of a case except for the removable module according to an exemplary embodiment of the present invention.

FIG. 10 is a cross-sectional view illustrating a mounting part mounted on electricity charging plug device mounting part according to an exemplary embodiment of the present invention.

FIG. 11 is a perspective view illustrating a charging connection device of electric vehicle according to an exemplary embodiment of the present invention.

FIG. 12 is a perspective view illustrating a coupled state between electric charging connection device and electric charging coupling device according to an exemplary embodiment of the present invention.

FIG. 13 is a perspective view illustrating electric charging coupling device according to an exemplary embodiment of the present invention.

FIG. 14 is an exploded perspective view of electric charging connection device according to an exemplary embodiment of the present invention.

FIG. 15 is a cross-sectional view of electric charging connection device and electric charging coupling device under mutually separated state.

FIG. 16 is a perspective view illustrating a guide gear according to an exemplary embodiment of the present invention.

FIG. 17 is a cross-sectional view of guide gear according to an exemplary embodiment of the present invention.

FIG. 18 is a cross-sectional view illustrating a coupled state between electric charging connection device and electric charging coupling device according to an exemplary embodiment of the present invention.

FIG. 19 is a cross-sectional view illustrating a moving path of guide path in a guide groove according to an exemplary embodiment of the present invention.

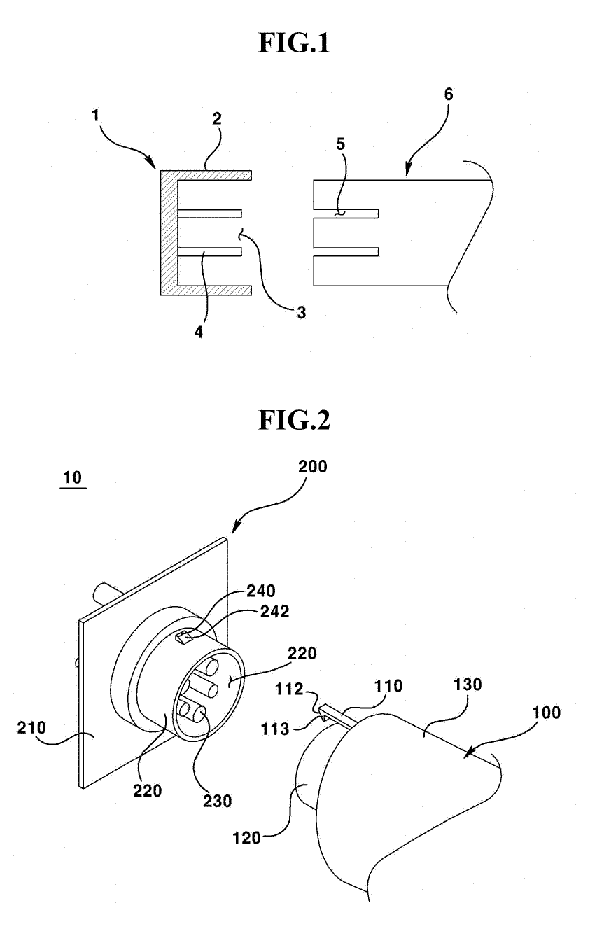

### BEST MODE

Example embodiments will now be described more fully with reference to the accompanying drawings, in which example embodiments are shown. Example embodiments may, however, be embodied in many different forms and should not be construed as being limited to the embodiments set forth herein; rather, many variations and modifications may be made to the above-described embodiment(s) without substantially departing from the spirit and principles of the techniques described herein. In describing the present invention, if it is determined that the detailed description on the related known technology makes the gist of the present invention unnecessarily ambiguous, the detailed description will be omitted.

The terminology used herein is for the purpose of describing particular embodiments only and is not intended to be limiting of example embodiments. As used herein, the singular forms are intended to include the plural forms as well, unless the context clearly indicates otherwise. It will be further understood that the terms “comprises” and/or “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first” and “second” are used herein to describe various regions, layers and/or portions, these regions, layers and/or portions should not be limited by these terms. These terms are only used to distinguish one region, layer or portion from another region, layer or portion.

Meantime, the electric vehicles in the present specification should be interpreted as being a concept including various vehicles including hybrid vehicles, hydrogen fuel cell vehicles, metal fuel cell vehicles, lithium ion battery vehicles, and nickel ion battery vehicles that use electricity as a driving power source after charging a battery.

Hereinafter, a front side of vehicle connector means a direction where the electricity charging plug device is coupled, and a rear side of vehicle connector means a direction opposite to the front side of the vehicle connector. Likewise, a front side of electricity charging plug device means a direction coupled by vehicle connector, and a rear side of electricity charging plug device means an opposite direction of the front side of electricity charging plug device, that is, a direction where a cable is coupled.

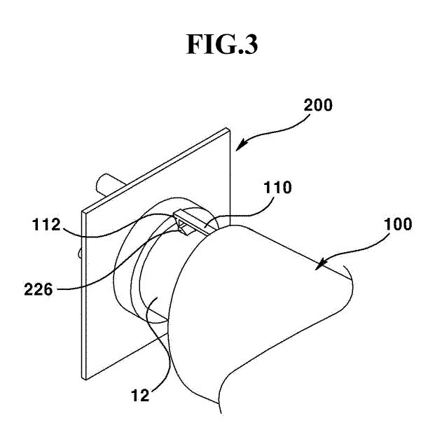

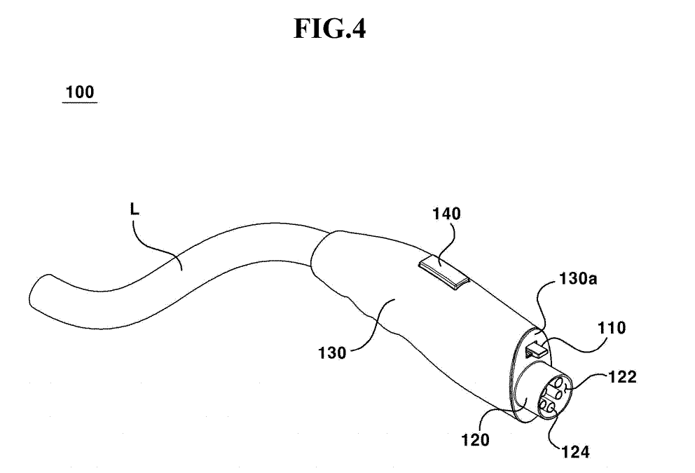

FIG. 2 is a perspective view of a charging connection device of an electric vehicle according to an exemplary embodiment of the present invention, FIG. 3 is a perspective view illustrating a coupled state between vehicle connector and electricity charging plug device according to an exemplary embodiment of the present invention, and FIG. 4 is a perspective view of electricity charging plug device according to an exemplary embodiment of the present invention.

Referring to FIGS. 2, 3 and 4, the charging connection device (10) of electric vehicle may include a vehicle connector (200) mounted on a vehicle, and an electricity charging plug device (100) mounted on a distal end of a cable of charging station.

The charging station may be stored with an electric energy necessary for charging the electric vehicle. Furthermore, when the electricity charging plug device (100) and the vehicle connector (200) are electrically connected, the electric energy may supply necessary electric energy to a battery mounted inside of the electric vehicle.

The vehicle connector (200) may be mounted on a vehicle. The vehicle connector (200) may be electrically connected to a battery disposed at an inside of the vehicle, and an electric energy supplied from the vehicle connector (200) may be transferred to the battery. The vehicle connector (200) may be disposed on the vehicle while being exposed to an outside area of vehicle, or may be installed at an inside of the vehicle to be selectively exposed to an outside area, whereby the vehicle connector (200) may be coupled to the electricity charging plug device (100).

The vehicle connector (200) may be disposed at a front surface thereof with electricity charging plug device mounting part (220) mounted with the electricity charging plug device (100). To be more specific, the electricity charging plug device mounting part (220) formed at a front surface of base (210) may be formed with a mounting hole (222) coupled by the electricity charging plug device (100). The mounting hole [symbol] (222) may be inserted by a mounting part (120, described later) of the electricity charging plug device (100), and an inside of the mounting hole (222) may be disposed with the mounting part (120).

The mounting hole (222) may be disposed at an inside with a charging terminal (230) electrically connected to a battery disposed at the vehicle. The charging terminal (230) may be electrically connected with a connection terminal (124, FIG. 4, described later) of the electricity charging plug device (100), whereby the charging of vehicle can be realized.

The electricity charging plug device (100) may include a housing (130) and the mounting part (120) disposed at a front surface of the housing (130). The housing (130) may be disposed at a distal end of a cable (L) extended from a charging station, and may be grasped by a user hand.

The mounting part (120) may take a shape of protruding to a front side from a distal end of the case (201), i.e., a front surface (130a) of the housing (130). At this time, a cross-sectional area of the mounting part (120) may be formed to be smaller than that of the housing (130). Furthermore, a front surface of the mounting part (120) may be formed with a connection terminal reception groove (122) accommodated by the connection terminal (124). Therefore, it should be interpreted that the mounting part (120) forms a border with a formed area of the connection terminal (124) at a front surface of housing (130). As discussed in the above, the connection terminal (124) may be electrically connected to the charging terminal (230) of vehicle connector (200), whereby the charging of vehicle can be implemented.

When the electricity charging plug device (100) and the vehicle connector (200) are coupled, the mounting part (120) may be inserted into the mounting hole (222), whereby the charging terminal (130) and the connection terminal (124) are electrically connected. To this end, a cross-sectional area of the mounting part (120) may be formed to be equal to or smaller than that of the mounting hole (222). In this case, when the cross-sectional area of the mounting part (120) is formed to be equal to or smaller than that of the mounting hole (222), a user can more easily insert the mounting part (120) into the mounting hole (222), or may easily pull out the mounting part (120) from the mounting hole (222).

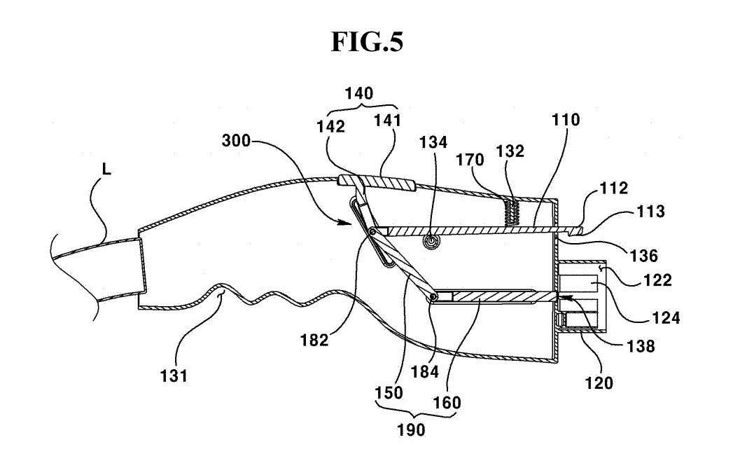

Meantime, the electricity charging plug device (100) may be formed with a locking part (110) in order to fix a coupled state between the electricity charging plug device (100) and the vehicle connector (200). The locking part (110) may be disposed at an inside of the housing (130) to allow a distal end thereof to be extended to an outside of housing (130) through an exposure hole (136, see FIG. 5) formed on a front surface (130a) of the housing (130). The outside-extended distal end of the locking part (110) may be formed with a locking lug (112) that is protruded downwardly.

Furthermore, an outer circumferential surface of the electricity charging plug device mounting part (220) of vehicle connector (200) may be also formed with a locking rib (240) on which the locking protrude (112) may be hitched. Thus, the locking lug (112) and the locking rib (240) may be respectively formed at mutually corresponding areas when the electricity charging plug device (100) and the vehicle connector (200) are coupled to allow a mutually selective locking and locking release. The number of the locking parts (110) and locking ribs (240) may be formed in a plural number in consideration of installation environment, so that the number of the locking parts (110) and locking ribs (240) may be mutually corresponded.

To be more specific, an external surface where the locking lug (112) and the locking rib (240) face each other may be respectively formed with mutually correspondingly shaped inclinations (242, 113). Hence, when the electricity charging plug device (100) is coupled to the vehicle connector (200), the locking protrude (112) can easily pass an upper surface of the locking rib (240) by the inclination (242, 113). Moreover, while the electricity charging plug device (100) is coupled to the vehicle connector (200), the locking between the locking lug (112) and the locking rib (240) is realized as shown in FIG. 3, whereby the coupled state can be securely maintained. That is, a rear surface of the locking lug (112) downwardly protruded from a lower surface at a distal end side of the locking part (110) may contact a rear surface of the locking rib (240) whereby the locking is realized, such that the electricity charging plug device (100) may be securely fixed to the vehicle connector (200).

Meantime, the release process between the locking protrude (112) and the locking rib (240) will be described later when the electricity charging plug device (100) is separated from the vehicle connector (200).

Hereinafter, an inner structure of the electricity charging plug device (100) will be described.

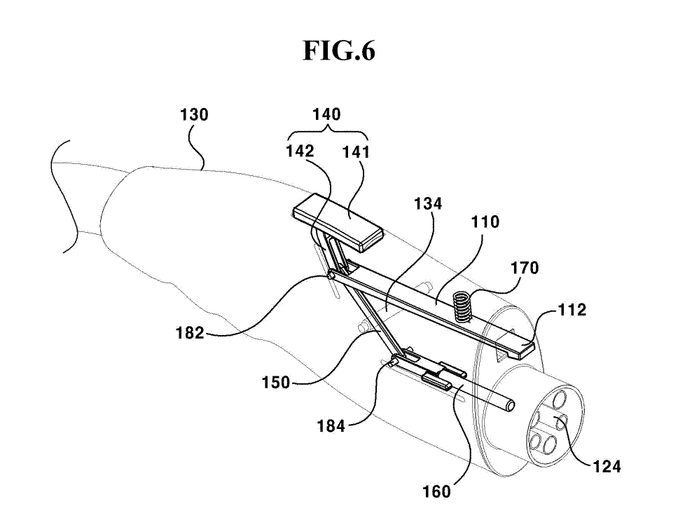

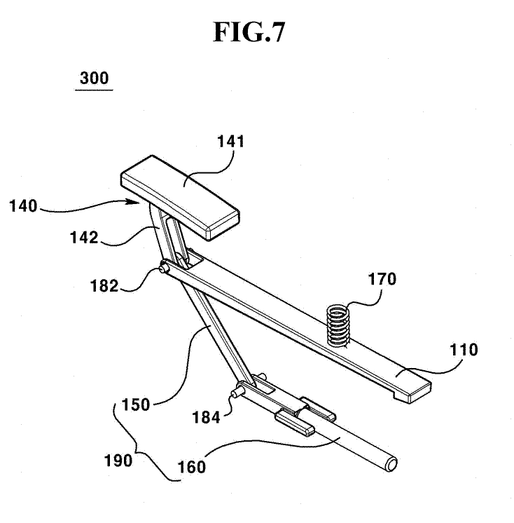

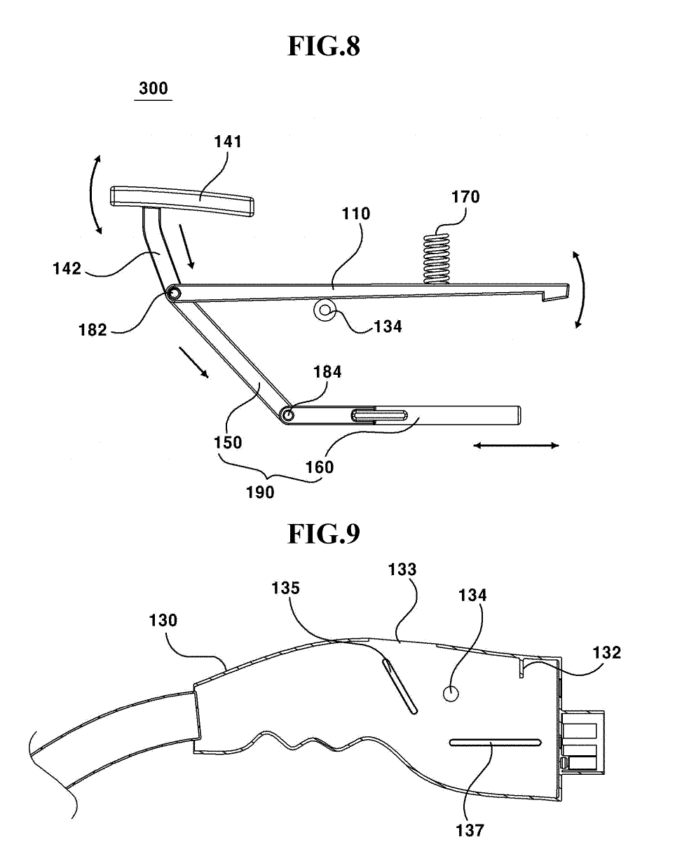

FIG. 5 is a cross-sectional view illustrating an inner element of electricity charging plug device according to an exemplary embodiment of the present invention, FIG. 6 is a perspective view of an inner element of electricity charging plug device according to an exemplary embodiment of the present invention, FIG. 7 is a perspective view of a removable (attachable/detachable) module according to an exemplary embodiment of the present invention, FIG. 8 is a cross-sectional view illustrating operation of removable module according to an exemplary embodiment of the present invention, and FIG. 9 is a cross-sectional view illustrating an inner state of a case except for the removable module according to an exemplary embodiment of the present invention.

Referring to FIGS. 5 to 7, the electricity charging plug device (100) according to an exemplary embodiment of the present invention may be disposed with a removable module (300). The removable module (300) may fix the coupled state between the electricity charging plug device (100) and the vehicle connector (200), or separate the electricity charging plug device (100) from the vehicle connector (200).

To be more specific, the removable module (300) may include an operating part (140) where a portion of the housing (130) is exposed to an outside, a locking part (110) connected to the operating part (140) and slidably coupled to a vehicle connector, a moving part (150) connected to the operating part (140) and having inclination changes according to the movement of the operating part (140), and a pressing part (160) connected to the moving part (150) so as to move toward the vehicle connector (200) according to the movement of the moving part (150)

The operating part (140) may transfer a driving force generated by manipulation of a user to the moving part (150) and to the locking part (110). To be more specific, the operating part (140) may include a button part (141) exposed to outside of the housing (130) and a force transfer part (142) downwardly extended from a lower surface of button part (141) to be accommodated into the housing (130). The button part (141) and the force transfer part (142) may be integrally formed.

The button part (141) may be pushed by a user body including a finger when the user grasps the housing (130). The housing (130) may be formed with an operating hole (133, see FIG. 8) in order to expose the button part (141) to an outside. When the button part (141) is pushed by a user, a pressing power applied to the button part (141) may be transferred to the force transfer part (142), and the force transfer part (142) may be also moved downwardly.

The force transfer part (142) may be coupled to a lower surface of the button part (141). The force transfer part (142) may be formed with an inclination as a lower end nears to a front surface of the housing (130) when viewed from a lateral surface. The force transfer part (142) may transfer the force applied to the button part (141) to the locking part (110) and the moving part (150).

Meantime, as illustrated in FIG. 8, the force transfer part (142) may be accommodated to a first space part (135) formed at a lower area of the operating hole (133) inside the housing (130). The first space part (135) may form a moving path of the force transfer part (142) inside the housing (130).

A pressing axis (190) may include the moving part (150) and the pressing part (160) connected to the moving part (150). The pressing axis (190) may be coupled at one end to a lower end of the operating part (140) to press a wall surface formed with the charging terminal (230) in the charging plug (200) in response to the operation of the operating part (140).

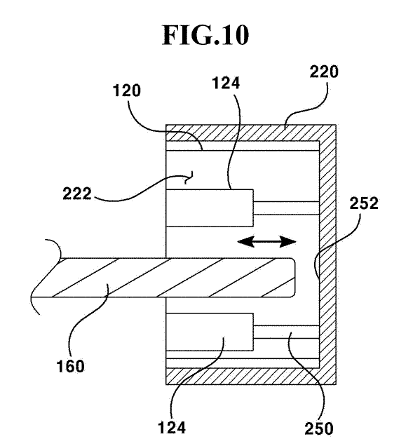

To be more specific, the pressing axis (190) may include a moving part (150) coupled at one end to the force transfer part (142) through a first axis (182) and a pressing part (160) coupled at the other end of the moving part (150) to press a floor surface (252, see FIG. 10) formed with the charging terminal (230).

The first axis (182) may form a rotating center for the force transfer part (142) and the moving part (150) by passing through an area where a lower end of the force transfer part (142) and an upper end of moving part (150) simultaneously meet. That is, when the operating part (140) is downwardly moved through a user's external force, the moving part (150) is rotated about the first axis (182).

The pressing part (160) may be connected at one end to the moving part (150) through a second axis (184), and extended at the other end to a front side of the electricity charging plug device (100). Thus, the pressing part (160) may be substantially disposed to a horizontal direction within the housing (130).

In other words, the pressing part (160) may be horizontally moved within the housing (130) by the pressing force transmitted by the force transfer part (142) and the moving part (150), which therefore may be interpreted that the pressing part (160) is linearly reciprocated within the housing (130). Furthermore, when the pressing part is forwardly moved, a portion of the pressing part (160) may be moved outside of the housing (130). That is, while the pressing part (160) is coupled at one end to the moving part (150), a distal area at the front side may be exposed outside of the housing (130). To this end, the housing (130) may be formed at a front surface with a through hole (138, see FIG. 5) in which the moving part (150) can move therethrough. The through hole (138) may be formed on a floor surface of a connection terminal reception groove (122) received by the connection terminal (124) on a front surface of the housing (130). Thus, when the mounting part (120) is inserted into the electricity charging plug device mounting part (220) of the vehicle connector (200), the pressing part (160) may apply a pressure to the floor surface (252) in response to the movement, the operation of the movement will be described later.

Meantime, the pressing axis (190) may be accommodated in a second space part (137) adjacent to a lower surface in an inner space of the housing (130). The second space part (137) may form a moving path of the pressing axis (190) inside the housing (130).

The locking part (110) may be coupled at one end to the first axis (182), and may be extended at the other end to an outside through an exposure hole (136) formed on the housing (130). Thus, when the force transfer part (142) is downwardly moved by operation of the operating part (140), the locking part (110) may be also rotated about the first axis (182).

Meantime, a support axis (134) supporting a lower side of the locking part (110) may be disposed within the housing (130). The support axis (134) may support a lower surface of the locking part (110) by being respectively coupled at both ends to both lateral sides at an inner area of the housing (130). At this time, the support axis (134) may be disposed at an area relatively adjacent to the first axis (182) about the locking part (110). Thus, a distal end coupled to the first axis (182) may be downwardly moved while the other opposite end may be upwardly moved, because a lower surface is supported by the support axis (134) when the locking part (110) is rotated by the force transfer part (142). That is, the support axis (134) may be interpreted as performing a role of a prop point for the locking part (110).

Meantime, the locking part (110) may be coupled at an upper surface with an elastic member (170). The elastic member (170) may be coupled at a lower end to the upper surface of the locking part (110), and may be coupled at an upper end to an inner upper surface of the housing (130). The inner upper surface of the housing (130) may be disposed with an elastic member coupling part (132) downwardly protruded for coupling of the elastic member (170). Meanwhile, the elastic member (170) may include a spring.

The elastic member (170) may provide elasticity toward the locking part (110) along the movement of the locking part (110). To be more specific, the locking part (110) may be moved upwardly by contact between a locking lug (112) and a locking rib (240) when the electricity charging plug device (100) is mounted on the vehicle connector (200). At this time, the elastic member (170) may provide the elasticity to enable the locking lug (112) to move downwardly again when the locking lug (112) passes an upper side of the locking rib (240) by being pressed while both ends are being pressed during contact to a lower surface of housing (130) and an upper surface of the locking part (110).

Furthermore, even if the locking part (110) is upwardly moved by external force generated by push of the operating part (140), the operating part (140) may be downwardly restored to an original position by the elastic member (170) when the user's external force disappears.

Meantime, because a distal end coupled to the first axis (182) of the locking part (110) is disposed at an outside of the force transfer part (142) and the moving part (150), the movement of the locking part (110) does not affect other driving force transfer axis (142, 150).

Hereinafter, an operation of electricity charging connection device of electric vehicle will be described according to an exemplary embodiment of the present invention.

FIG. 10 is a cross-sectional view illustrating a mounting part mounted on electricity charging plug device mounting part according to an exemplary embodiment of the present invention.

Referring to FIGS. 5, 8 and 10, the electricity charging plug device (100) is coupled to the vehicle connector (200) in order to charge an electric vehicle. As discussed in the foregoing, the coupling between the electricity charging plug device (100) and the vehicle connector (200) may be realized by insertion of the mounting part (120) formed on the electricity charging plug device mounting device (220) into the mounting hole (222) for contact between the charging terminal (250) and the connection terminal (124).

At this time, because of mutual contact between an inclination (113) of the locking lug (112) and an inclination (242) of locking rib (240), the locking part (110) may be upwardly moved within the housing (130). Furthermore, when the locking lug (112) passes the locking rib (240) to be disposed at a rear surface of the locking rib (240), the locking part (110) is downwardly moved by the elasticity of the elastic member (170) to form a locked state between the locking lug (112) and the locking rib (240). As a result, even if there is generated a high voltage during charging, the coupled state between the electricity charging plug device (100) and the vehicle connector (200) may be securely maintained.

Next, when the charging is finished, and the electricity charging plug device (100) is disengaged from the vehicle connector (200), a user pushes the button part (141) of the operating part (140). Due to push to the button part (141), the force transfer part (142) is moved downwardly, whereby a distal end at a front side of the locking part (110) is upwardly moved by the support axis (134) as illustrated in FIG. 8. That is, the upwardly movement of the locking part (110) may be understood that the locking lug (112) is moved to a position of being disengaged from the locking rib (240). Furthermore, a driving force can be transmitted to the pressing part (160) and the moving part (150) by the downwardly movement of the force transfer part (142), and the pressing part (160) is moved to a front side. A partial area of the pressing part (160) may be moved to an outside through the through hole (138) by the forward movement of the pressing part (160), whereby, as illustrated in FIG. 10, a distal end at the front side of the pressing part (160) may apply a force to a floor surface (252) of the mounting hole (222). Furthermore, the mounting part (120) may be easily disengaged from the mounting hole (222) by the pressing force of the pressing part (1560) that pushes out the floor surface.

There has been conventionally an inconvenience of incurring more force because an external force of pulling the electricity charging plug device backward was applied in order to separate the electricity charging plug device from a vehicle connector.

According to the charging connection device (10) of an electric vehicle according to an exemplary embodiment of the present invention, the pressing part (160) applies a pressure while being contacted to the floor surface (252) when the electricity charging plug device (100) is separated from the vehicle connector (200), such that there is an advantageous effect of the electricity charging plug device (100) being easily separated. That is, a user can separate the electricity charging plug device (100) through operation of the operating part (140) without applying a separate force.

Hereinafter, the electricity charging connection device will be described according to an exemplary embodiment of the present invention.

Hereinafter, a front side of the electricity charging connection device is defined as a direction where electricity charging coupling device is coupled, and a rear side of the electricity charging connection device is defined as an opposite direction of the front side where electricity charging coupling device is coupled. Likewise, a front side of the electricity charging coupling device is defined as a direction where the electricity charging connection device is coupled and a rear side of the electricity charging coupling device is defined as an opposite direction of the front side where the electricity charging connection device is coupled.

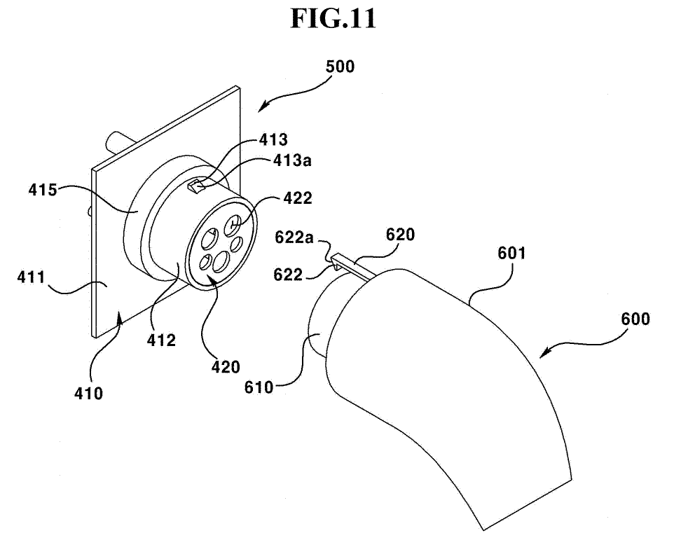

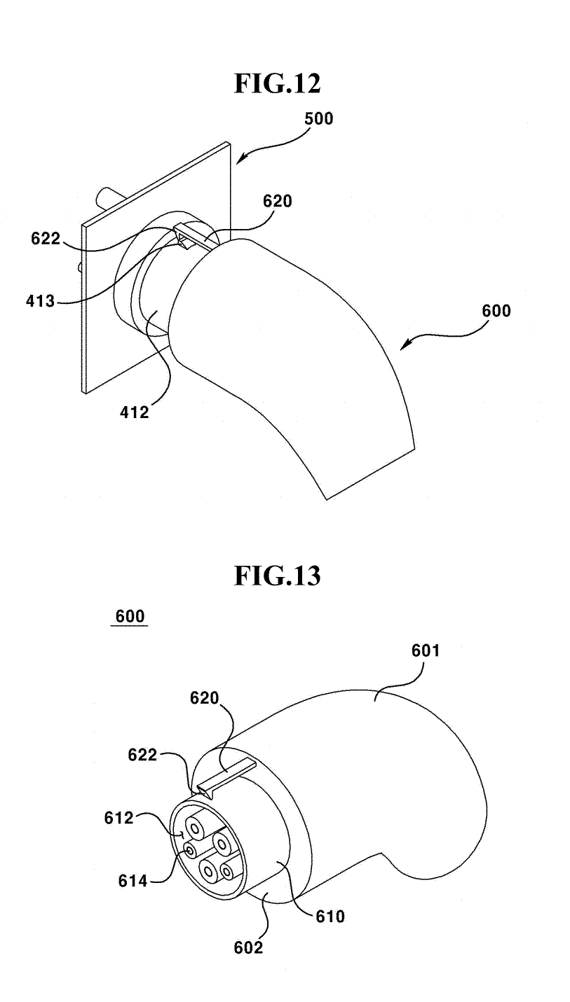

FIG. 11 is a perspective view illustrating a charging connection device of electric vehicle according to an exemplary embodiment of the present invention, FIG. 12 is a perspective view illustrating a coupled state between electric charging connection device and electric charging coupling device according to an exemplary embodiment of the present invention, and FIG. 13 is a perspective view illustrating electric charging coupling device according to an exemplary embodiment of the present invention.

Referring to FIGS. 11 to 13, the charging connection device of electric vehicle according to an exemplary embodiment of the present invention may include electricity charging connection device (500) and an electricity charging coupling device (600) mounted on a distal end of a cable of a charging station.

The charging station may store an electric energy necessary for battery charging of an electric vehicle. Furthermore, when the electricity charging connection device (500) and the electricity charging coupling device (600) are electrically connected, the electric energy may be supplied to a battery mounted inside the electric vehicle as an electric energy.

The electricity charging connection device (500) may be mounted on a vehicle. The electricity charging connection device (500) may be electrically connected to a battery disposed at an inside of the vehicle to allow an electric energy supplied from the electricity charging connection device (500) to be transmitted to the battery. The electricity charging connection device (500) may be coupled to the electricity charging coupling device (600) by being so disposed as to be exposed to an outside of the vehicle, or so disposed as to be installed inside the vehicle for selective exposure to an outside of the vehicle.

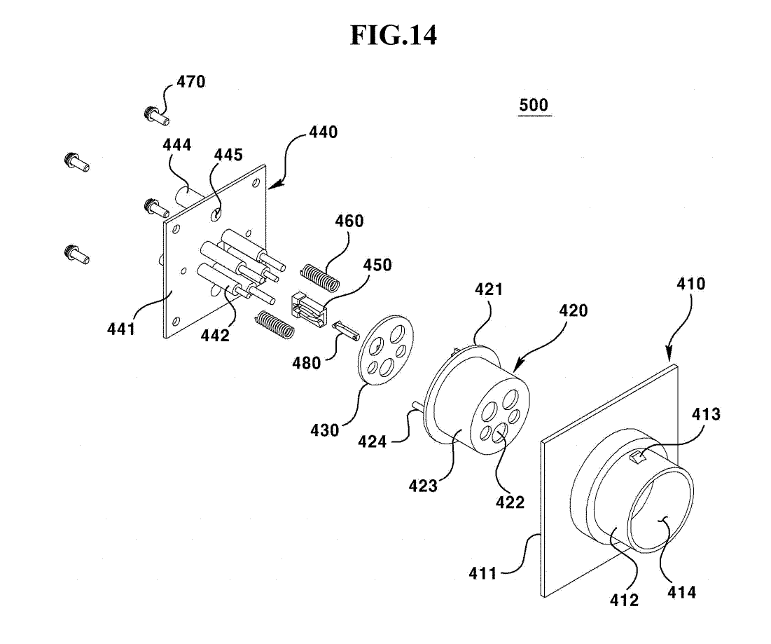

The electricity charging connection device (500) may include a mounting part (412), on one surface of which is mounted with the electricity charging coupling device (600). The mounting part (412) may be formed with a coupling groove (414, see FIG. 14) into which a connector coupling part (610) of the electricity charging coupling device (412) is inserted. Furthermore, the connector coupling part (610) formed at a distal end of the electricity charging coupling device (600) may be coupled to the mounting part (412) to allow the electricity charging connection device (500) to be electrically connected by the electricity charging coupling device (600).

The electricity charging coupling device (600) may include a body (601) grasped by a user and the connector coupling part (610) disposed at a distal end of the body (601). The body (601) may be disposed at a distal end of the charging station and may be grasped by a user's hand.

The connector coupling part (610) may be protrusively formed from a distal end of the body (601), i.e., from a cross-section (601) of the body (601). At this time, a cross-sectional area of the connector coupling part (610) may be formed to be smaller than that of the body (601). Furthermore, a front surface of the connector coupling part (610) may be formed with a plug reception groove (612) accommodating a charging plug (614). As a result, the connector coupling part (610) may be interpreted as forming a border of a charging terminal (442) on a cross-section of the body (601).

The charging plug (614) may be contacted or connected to a charging terminal (442, described later) of the electricity charging connection device (500), whereby an electric connection between the electricity charging connection device (500) and the electricity charging coupling device (600) may be realized.

Meantime, any one side spaced apart from the connector coupling part (610) on a cross -section of the body (601) may be formed with a locking part (620) protruded from the cross -section (601). Moreover, the mounting part (412) of the electricity charging connection device (500), i.e., the outer circumferential surface of the coupling groove (414), may be protrusively formed with a locking lug (413) locked with the locking part (620). The locking part (620) and the locking lug (413) may face each other when the electricity charging connection device (500) and the electricity charging coupling device (600) are coupled to allow realizing mutually selective locking and locking release.

To be more specific, a distal end of the locking part (620) may be formed with a locking rib (622) protruded from a lower surface. Moreover, a surface faced by the locking rib (622) and the locking lug (413) may be respectively formed with inclinations (413a, 622a), each having a corresponding shape. Therefore, when the electricity charging coupling device (600) is coupled by the electricity charging connection device (500), the locking rib (622) can easily pass the locking lug (413) thanks to the inclinations (413a, 622a). Furthermore, while the electricity charging coupling device (600) is coupled to the electricity charging connection device (500), the locking is realized between the locking rib (622) and the locking lug (413), as illustrated in FIG. 12, to thereby maintain a secure coupled state.

Hereinafter, configuration for the charging connection between the electricity charging coupling device (600) is coupled to the electricity charging connection device (500) will be described.

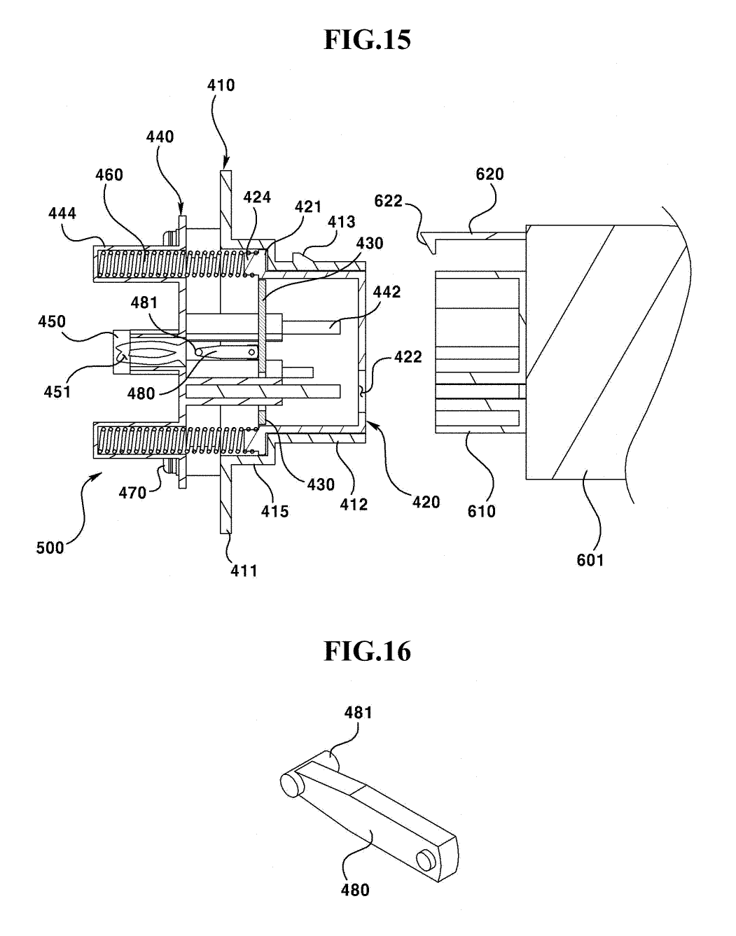

FIG. 14 is an exploded perspective view of electric charging connection device according to an exemplary embodiment of the present invention, FIG. 15 is a cross-sectional view of electric charging connection device and electric charging coupling device under mutually separated state.

Referring to FIGS. 11, 14 and 15, the electric charging connection device (500) according to an exemplary embodiment of the present invention may include a base (410) including a coupling groove (414) into which the charging plug (614) is inserted, a fixing frame (440) formed with a charging terminal (442) electrically connected to the charging plug (614), a moving frame (420) interposed between the fixing frame (440) and the base (410) to horizontally move in response to the coupling with the electricity charging coupling device (600), and an elastic member (460) applying elasticity to the moving frame (420) by being contacted to the moving frame (420).

The base (410) may be formed at a front surface with a mounting part (412). To be more specific, the base (410) may include a plate-shaped plate (411) and a mounting part (412) where a partial portion of the front surface of the plate (411) is protruded to a front side. The mounting part (412) may be formed with a coupling groove (414) into which the connector coupling part (610) of the electricity charging coupling device (600) can be inserted. The coupling groove (414) may be so formed as to pass through a rear surface of the plate (411) from a front surface of the mounting part (412) to allow the charging terminal (442) of the fixing frame (440) to be exposed to outside by the coupling groove (414).

As discussed from the foregoing, the connector coupling part (610) of the electricity charging coupling device (600) may be inserted into the mounting part (412) when an electric vehicle is charged. Toward this end, when the electricity charging coupling device (600) and the electric charging connection device (500) are coupled, an outer circumferential surface of the connector coupling part (610) may be disposed on an inside of an inner circumferential surface of the coupling groove (414). To this end, a cross-sectional area of the connector coupling part (610) may be equal to or smaller than that of the coupling groove (414). When the cross -sectional area of the connector coupling part (610) is made to be smaller than that of the coupling groove (414), the connector coupling part (610) may have an advantageous effect of allowing being easily inserted into the coupling groove (414).

Meanwhile, a connection part (415) may be interposed between the plate (411) and the mounting part (412) to connect the plate (411) and the mounting part (412). The cross-sectional area of the connection part (415) may be smaller than that of the plate (411) and may be greater than that of the mounting part (412), and an inner circumferential surface of the connection part (415) corresponding to the coupling groove (414) may be accommodated with a moving frame body (423, described later) of the moving frame (420).

The fixing frame (440) may be disposed at a rear side of the base (410). A front surface of the fixing frame, i.e., a surface facing the base (410), may be formed with one or more charging terminals (442). For example, the charging terminal (442) may be so disposed as to allow five (5) terminals to be mutually spaced apart.

To be more specific, the fixing frame (440) may include a fixing frame body (441), an elastic member reception part (444) extended from a rear surface of the fixing frame body (441) to a rear side to include a reception groove (445) to accommodate an elastic member (460, described later),and a guide part (450) extended from a rear surface of the fixing frame body (441) spaced apart from the elastic member reception part (444) to a rear side to guide a guide gear (480, described later).

The fixing frame body (441) may be screw-connected at a marginal area with a marginal area of the base (410) to be mutually coupled to the base (410). For example, four (4) edges of the fixing frame body (441) may be formed with screw holes through which screws (470) can pass, to be coupled with the base (410).

The elastic member reception part (444) may be coupled to a rear surface of the fixing frame body (441). Moreover, a front surface of the fixing frame body (441) may be formed with a reception groove (445) extended to a rear side of the elastic member reception part (444) to allow accommodating the elastic member (460). That is, the reception groove (445) may be interpreted to be extended along a lengthwise direction of the elastic member reception part (444) from a front surface of the fixing frame body (441).

The guide part (450) may be also disposed at any one area spaced apart from the elastic member reception part (444) in the rear surface of body (441) of the fixing frame body (441). Moreover, the fixing frame (440) may include a guide groove (451). To be more specific, the guide part (450) may be formed with a guide groove (451) extended from a front surface of the fixing frame body (441) to a rear side of the guide part (450) to allow the guide gear (480) to be selectively inserted in response to the movement of the moving frame (420). In other words, the guide groove (451) may be interpreted as being recessed to a rear side along a lengthwise direction of the guide part (450) from a front surface of the fixing frame body (441).

The moving frame (420) may be interposed between the base (410) and the fixing frame (440). To be more specific, the moving frame (420) may include a moving frame body (423) disposed at an inside of the coupling groove (414) and a stopper (421) having a diameter greater than that of the moving frame body (423). A rear surface of the moving frame body (423) may be coupled by the guide coupling part (430).

The stopper (421) of the moving frame body (423) may be disposed at an inside of the connection part (415). Toward this end, a cross-sectional area of the stopper (421) may be formed to be equal to or smaller than that of the connection part (415). Furthermore, a cross -sectional area of the coupling groove (414) may be formed to be smaller than that of the stopper (421). This is to be interpreted that when the coupling groove (414) is formed to be round, a diameter of the coupling groove (414) may be interpreted as being formed smaller than that of the stopper (421).

A rear surface of stopper (421) may be formed with an elastic member coupling part (424) protruding to a rear side. The elastic member coupling part (424) may be inserted by one end of the elastic member (460) to allow selectively applying a pressure to the elastic member (460) in response to the movement of the moving frame (420). That is, the elastic member (460) may be inserted at one end into one surface of the moving frame (420), i.e., into the elastic member coupling part (424), and may be accommodated at the other end into the elastic member reception part (444) through the reception groove (445). Moreover, when the moving frame (420) is moved backward, the elastic member (460) is compressed to generate an elasticity to be elongated, the operating process of which will be described later. Meantime, the elastic member coupling part (424) may be disposed at a rear surface of the moving frame body (423) in correspondence to the number of the elastic members (460).

Furthermore, the elastic member (460) may provide elasticity for movement of the moving frame (420). For example, the elastic member (460) may be a spring. That is, the elastic member (460) may be compressed while being accommodated into the elastic member reception part (444) when moving to a rear side of the moving frame (420), and may provide elasticity toward a front side when moving to a front side of the moving frame (420) to allow an easy movement of the moving frame (420).

The moving frame body (423) may be formed by allowing a portion of the stopper (421) to be protruded to a front side. That is, a portion of front surface of the moving frame body (423) may be formed by being protruded to a front side to allow having a cross-sectional area smaller than that of the stopper (421). At this time, an inside of the moving frame body (423) may be formed with a hollow hole to allow the charging terminal (442) to be selectively accommodated.

Before the electricity charging coupling device (600) is coupled to the electricity charging connection device (500), the moving frame body (423) may be accommodated into the coupling groove (414). Toward this end, the shape of the cross-section of the moving frame body (423) may correspond to that of the coupling groove (414). Moreover, the connector coupling part (610) may push the moving frame body (423) to a rear side in response to a user's pressing force when the connector coupling part (601) of the electricity charging coupling device (600) is mounted on the coupling groove (414).

A front surface of the moving frame body (423) may be formed with a through hole (422) in order to allow the charging terminal (442) to selectively pass therethrough in response to the movement of the moving frame (420). The through hole (422) may be formed in correspondence to the position and the number of the charging terminals (442). Thus, when the moving frame (420) is moved to a rear side by being mounted with the electricity charging coupling device (600), the charging terminal (442) may pass through the through hole (422) to allow the charging terminal (442) and the charging plug (614, see FIG. 13) to be mutually contacted.

The guide coupling part (430) may be coupled to a rear surface of the moving frame body (423). The guide coupling part (430) may be also formed with a through hole (430) into which the charging terminal (442) can be inserted. Moreover, as illustrated in FIG. 15, a rear surface of the guide coupling part (430) may be coupled to the guide gear (480). The guide gear (480) is an element for fixing or converting the position of the moving frame (420) in response to the movement of the moving frame (420), and may be extended to an axis direction toward a rear surface from the rear surface of the guide coupling part (430).

Furthermore, a distal end of the guide gear (480) may be formed with a guide lug (481). The guide lug (481) may move on a path formed at an inside of the guide part (450) in response to the movement of the moving frame (420), and fix the moving state of the moving frame (420) or easily restore to the original position, the operating process of which will be described later.

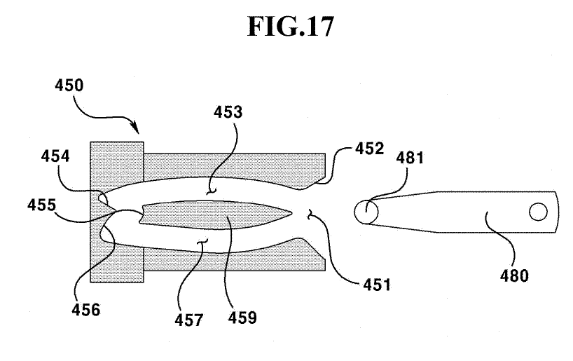

FIG. 16 is a perspective view illustrating a guide gear according to an exemplary embodiment of the present invention, and FIG. 17 is a cross-sectional view of guide gear according to an exemplary embodiment of the present invention.

Referring to FIGS. 15 and 17, the guide gear (480) and the guide part (450) may be respectively formed with the fixing frame (440) and the moving frame (420) to allow the same to face each other. A distal end of the guide gear (480) may be formed with a guide lug (481) protruding from an outside in order to move along the guide groove (451, described later) as illustrated in FIG. 16.

Moreover, as shown in FIG. 17, the guide part (450) may be formed with a guide groove (451) which is a path on which the guide lug (481) moves. The guide groove (451) may be formed by being recessed from a front surface of the guide part (450) to a rear side to establish a moving path of the guide lug (481) in response to the movement of the guide gear (480). That is, when the moving frame (420) is moved to a rear side, the guide lug (481) is moved on a path set up by the guide groove (451) to fix the moved arrangement state of the moving frame (420). Furthermore, when the moving frame (420) is moved to a front side, the moving path is established to allow moving to a set direction.

To be more specific, the guide groove (451) may be respectively formed with an incoming path (453) formed at an inlet on an inner circumferential surface side starting with a first inclination (452) for drawing in the guide lug (481) and an outgoing path (457)formed for drawing out the guide lug (481). Furthermore, a border wall (459) may be formed between the incoming path (453) and the outgoing path (457). That is, the first inclination (452) formed on the inner circumferential surface at inlet of the guide groove may be formed to guide the guide lug (481) to the incoming path (453).

The guide lug (481) may be moved to a counterclockwise direction based on FIG. 17. That is, when the moving frame (420) is moved backward, the guide gear (480) formed with the guide lug (481) may be coupled with the guide part (450). At this time, the guide lug (481) may be guided to the incoming path (453) by the first inclination (452).

Furthermore, a second inclination (454) may be likewise formed on a floor surface of the incoming path (453), i.e., a floor surface of the guide groove (451) at the incoming path (453) side. The second inclination (454) is provided to guide the guide lug (481) to a reception groove (455) formed at a rear surface of border wall (459), where when the guide lug (481) is brought into contact with the reception groove (455), the position of the guide lug (481) may be fixed. The reception groove (455) may be interposed between the incoming path (453) and the outgoing path (457) where the guide lug (481) is accommodated thereon. This is a state where the electricity charging connection device (500) and the electricity charging coupling device (600) are mutually coupled, i.e., where an electric vehicle is being charged, and therefore, may be interpreted as fixing a state of the moving frame (420) being backwardly moved.

Next, when a pressing force toward a rear side is applied again to the moving frame (420), the guide lug (481) may be guided to the incoming path (457) by a third inclination (456) formed on a floor surface facing the reception groove (455) on the guide groove (451), i.e., a floor surface of the guide groove (451) formed at the incoming path (457) side. At this time, the state where the guide lug (481) is disengaged from the guide part (450) along the outgoing path (457) may be interpreted as a state where the moving frame (420) is moved to a front side again, i.e., a state where the electricity charging coupling device (600) is disengaged from the electricity charging connection device (500). Thus, the guide lug (481) may be disengaged from the guide groove (451) along the outgoing path (457), and the moving frame (420) can move forward in order to be disposed at an inside of the coupling groove (414).

Hereinafter, an operation of the charging connection device (410) of an electric vehicle according to an exemplary embodiment of the present invention will be described.

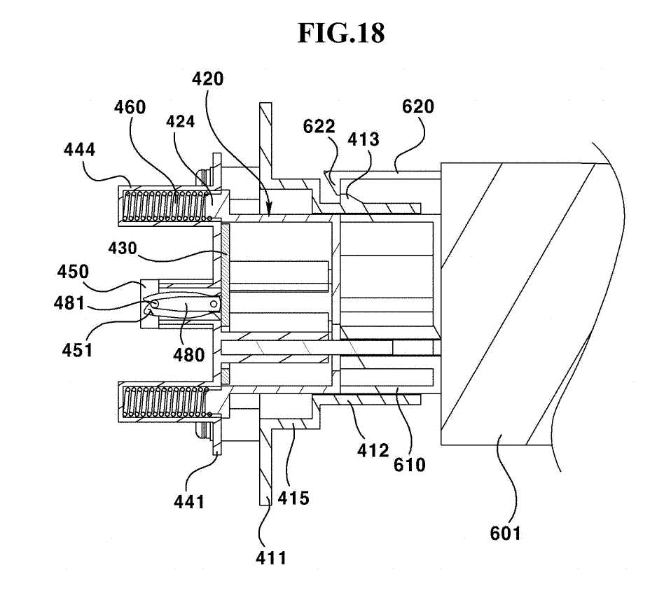

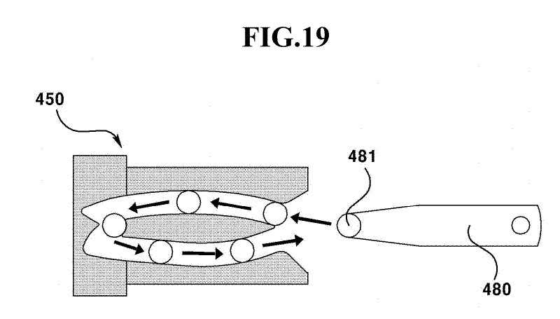

FIG. 18 is a cross-sectional view illustrating a coupled state between electric charging connection device and electric charging coupling device according to an exemplary embodiment of the present invention, FIG. 19 is a cross-sectional view illustrating a moving path of guide path in a guide groove according to an exemplary embodiment of the present invention.

Referring to FIGS. 15, 18 and 19, first, a connector coupling part (610) of the electricity charging coupling device (600) is inserted into a coupling groove (414) for charging. As a result, the moving frame (420) is moved backward while being accommodated into the coupling groove (414). Moreover, the charging of the electric vehicle is completed by allowing being contacted to the charging plug (614) of the electricity charging coupling device (600) while being inserted into the through hole (422) formed at the moving frame body (423).

Meantime, the elastic member (460) is compressed by being accommodated into the elastic member reception groove (445) in response to the movement of the moving frame (420), whereby the elastic member (460) may generate elasticity toward a front side. Furthermore, the guide lug (481) may be accommodated into the reception groove (455) of the guide groove (451) to fix the rearward moving state of the moving frame (420), i.e., to fix the coupled state between the electricity charging connection device (500) and the electricity charging coupling device (600).

As a result, even if a cross-sectional area of the connector coupling part (610) is formed smaller than that of the coupling groove (414), the coupling state of the electricity charging coupling device (600) can be advantageously air-tightly maintained by the support structure of the guide groove (451) and the reception groove (455).

Next, when the charging of the electric vehicle is completed, the connector coupling part (610) applies a force backward in order to press the moving frame (420) while the user graphs the electricity charging coupling device (600), whereby the guide lug (481) accommodated in the reception groove (455) is guided to the outgoing path (458) by the third inclination to move the moving frame (420) to a front side. That is, the force where the guide lug (481) is disengaged from the guide groove (451) along the outgoing path (458) is originated from the elasticity of the elastic member (460), where the moving frame (420) can be easily moved to a front side by the elongation of the elastic member (460). Thus, the moving frame (420) may be disposed at an original first place, i.e., at an inside of the coupling groove (414).

The exemplary embodiment of the present invention has an advantageous effect in that the coupling stability between the electricity charging coupling device and the electricity charging connection device can be guaranteed by fixing the moving state of the moving frame by accommodating the guide lug into a stop groove.

Furthermore, the exemplary embodiment of the present invention has an advantageous effect in that a user can easily charge an electric vehicle with less force because the electricity charging coupling device is disengaged from the electricity charging connection device using the elasticity of the elastic member.

Moreover, although the present specification has separately explained the electricity charging plug device and the electricity charging connection device, it should be apparent that the aforesaid electricity charging plug device may be coupled by the post-mentioned electricity charging connection device. At this time, the electricity charging plug device and the electricity charging connection device can provide electricity necessary for driving an electric vehicle by allowing the electricity charging plug device to be removably coupled to the electricity charging connection device as an electricity charging device.

Although the abovementioned embodiments according to the present invention have been described in detail with reference to the above specific examples, the embodiments are, however, intended to be illustrative only, and thereby do not limit the scope of protection of the present invention. Thereby, it should be appreciated by the skilled in the art that changes, modifications and amendments to the above examples may be made without deviating from the scope of protection of the invention.

1. An electricity charging plug device, the device comprising:
a housing;
an operating part of which a portion is exposed to the outside of the housing;
a locking part connected to the operating part through a first pin and slidably coupled to a vehicle connector when the device is coupled to the vehicle connector;
a moving part connected to the operating part through the first pin and having inclination changes according to the movement of the operating part; and
a pressing part connected to the moving part through a second pin spaced apart from the first pin so as to move toward the vehicle connector according to the movement of the moving part, wherein
the pressing part protrudes outwards of the housing according to the movement of the moving part to press the vehicle connector.

2. The electricity charging plug device of claim 1, comprising a support pin disposed in the housing and supporting a lower surface of the engaging portion.

3. The electricity charging plug device of claim 1, wherein the locking part is disposed on an upper side of the pressing part.

4. The electricity charging plug device of claim 1, wherein the operating part includes a button part that is pressed by a user, and a force transfer part that transfers a force applied to the operating part to the locking part and the moving part.

5. The electricity charging plug device of claim 1, wherein the locking part includes an elastic member that provides elasticity to the locking part.

6. The electricity charging plug device of claim 1, wherein the device comprises a connection terminal connected to the vehicle connector.

7. An electricity charging connection device, comprising:
a base including a coupling groove into which a charging plug is inserted;
a fixing frame formed with a charging terminal electrically connected to the charging plug;
a moving frame interposed between the fixing frame and the base; and
an elastic member applying elasticity to the moving frame by being contacted to the moving frame; wherein
the fixing frame includes a guide groove and the moving frame includes a guide gear moving along the guide groove, and
the guide groove includes an incoming path into which the guide lug comes in and an outgoing path from which the guide lug goes out.

8. The electricity charging connection device of claim 7, wherein the moving frame includes a moving frame body disposed at an inside of the coupling groove and a stopper having a diameter greater than that of the body.

9. The electricity charging connection device of claim 7, wherein the coupling groove of the base is formed with a diameter smaller than that of the stopper.

10. The electricity charging connection device of claim 7, wherein the elastic member is such that a distal end is contacted to one surface of the moving frame and the other end is accommodated into an elastic member reception groove of the fixing frame.

11. The electricity charging connection device of claim 7, wherein the guide gear includes a guide lug moving along the guide groove.

12. The electricity charging connection device of claim 11, wherein a reception groove is included between the incoming path and the outgoing path in order to accommodate the guide lug.

13. The electricity charging connection device of claim 7, wherein an inner circumferential surface at an inlet side of the guide groove is formed with an inclination toward the incoming path of the guide lug.

14. The electricity charging connection device of claim 7, wherein the moving frame includes a guide coupling part coupled to the guide gear.

15. The electricity charging connection device of claim 7, wherein the moving frame includes a plurality of through holes through which the charging terminal passes.

16. The electricity charging connection device of claim 7, wherein the base includes a locking lug that is protruded from an outer circumferential surface of the coupling groove.

17. The electricity charging connection device of claim 8, wherein the stopper includes, at a rear surface thereof, an elastic member coupling part into which one end of the elastic member is inserted.

18. An electricity charging device, comprising:
an electricity charging connection device; and
an electricity charging plug device attachably and detachably coupled to the electricity charging connection device, wherein
the electricity charging connection device comprises:
a base including a coupling groove into which a charging plug is inserted;
a fixing frame formed with a charging terminal electrically connected to the charging plug;
a moving frame interposed between the fixing frame and the base; and
an elastic member applying elasticity to the moving frame by being contacted to the moving frame, wherein
the fixing frame includes therein a guide groove, and the moving frame includes a guide gear moving along the guide groove, wherein
the electricity charging plug device comprises:
a housing;
an operating part of which a portion is exposed to the outside of the housing;
a locking part connected to the operating part through the first pin and slidably coupled to a vehicle connector when the device is coupled to the vehicle connector;
a moving part connected to the operating part through the first pin and having inclination changes according to the movement of the operating part; and
a pressing part connected to the moving part through a second pin spaced apart from the first pin so as to move toward the vehicle connector according to the movement of the moving part, wherein
the pressing part protrudes outwards of the housing according to the movement of the moving part to press the vehicle connector.

19. An electric vehicle mounted with electricity charging connection device for charging, wherein the electricity charging connection device comprises:
a base including a coupling groove into which a charging plug is inserted;
a fixing frame formed with a charging terminal electrically connected to the charging plug;
a moving frame interposed between the fixing frame and the base; and
an elastic member applying elasticity to the moving frame by being contacted to the moving frame; wherein
the fixing frame includes a guide groove and the moving frame includes a guide gear moving along the guide groove, and
the guide groove includes an incoming path into which the guide lug comes in and an outgoing path from which the guide lug goes out.

20. The electricity charging plug device of claim 5, wherein an one end of the elastic member is coupled to the inner surface of the housing, and an other end of the elastic member is coupled to the upper surface of the engagement portion.
